(19) United States
(12) Patent Application Publication
(10) Pub. No.: US 2026/0351203 A1
(43) Pub. Date: Nov. 5, 2026

(54) BACKLIGHT BRIGHTNESS CONTROL METHOD AND APPARATUS, TERMINAL DEVICE, AND STORAGE MEDIUM

(71) Applicant: SHENZHEN TCL NEW TECHNOLOGY CO., LTD., Shenzhen, Guangdong (CN)

(72) Inventors: Qing FANG, Shenzhen, Guangdong (CN); Renli XIE, Shenzhen, Guangdong (CN); Yixin CHEN, Shenzhen, Guangdong (CN)

(73) Assignee: SHENZHEN TCL NEW TECHNOLOGY CO., LTD., Shenzhen, Guangdong (CN)

(21) Appl. No.: 19/120,797

(22) PCT Filed: Oct. 14, 2022
(86) PCT No.: PCT/CN2022/125457

§ 371 Date: Apr. 14, 2025

(51) Int. Cl. G09G 3/34; G09G 3/36

(52) U.S. Cl. CPC G09G 3/3406; G09G 3/3648; G09G 2320/0247; G09G 2320/0626; G09G 2340/0435; G09G 2360/16

(57) ABSTRACT

A backlight brightness control method includes: for a time interval between the last time a frame synchronization signal is received and the time when a backlight compensation coefficient is calculated, calculating a frame refresh rate of a display device in the time interval; acquiring an image frame to be displayed, and determining a pixel signal feature of said image frame; based on the frame refresh rate, the pixel signal feature, and backlight setting parameters of the display device, calculating the backlight compensation coefficient corresponding to said image frame; and based on the backlight compensation coefficient, controlling backlight brightness when said image frame is displayed on the display device, wherein the backlight compensation coefficient is calculated based on the real-time frame refresh rate, the pixel signal feature and the backlight setting parameters.

### FIELD OF THE INVENTION

The present disclosure relates to the display technology, and in particular, to a backlight brightness control method, apparatus, a terminal device, and storage medium.

### BACKGROUND

With the rapid technology development, in order to avoid screen tearing due to the non-synchronization of the frame rate of the content to be displayed and the refresh rate of the display device, the Variable Refresh Rate (VRR) technology is used to enable users to get a better visual experience.

When the display device switches between high and low refresh rates or is in the working state of low refresh rate for a long time, because the corresponding driving voltage of each pixel on the equivalent driving circuit of the display device is refreshed once under the synchronization signal of each frame and is stored by its equivalent capacitance. However, the equivalent capacitance has leakage, and the driving voltage will be affected. On the basis of the backlight parameters of the display device keep unchanged, the light transmitted by the display device will be affected, resulting in the decrease in display brightness. The different refresh rates correspond to the different leakage of capacitors and thus result in different display brightness. That is, there will be a brightness jump problem, and the most intuitive feeling of the brightness change for the human eye is flickering, which affects the user's visual experience.

### SUMMARY

### Technical problem

Conventionally, in the case of leakage of the equivalent capacitor, the driving voltage will be dropped, and the light transmitted by the display device will be affected on the basis of the backlight parameters of the display device keep unchanged. The different refresh rates correspond to the different leakage of capacitors and thus result in different display brightness. That is, there will be a brightness jump problem, and the most intuitive feeling of the brightness change for the human eye is flickering, which affects the user's visual experience.

### Solution to Technical Problem

### Technical Solution

One objective of an embodiment of the present disclosure is to provide a backlight brightness control method and a related device, which can compensate the backlight brightness of the display device in real time, so that the display device can have a stable brightness when the VRR technology is being adopted, and the user's visual experience is improved.

According to an embodiment of the present disclosure, a method for controlling a brightness of a backlight is disclosed. The method comprises:
calculating a frame refresh rate of a display device in a time interval between a time when the frame synchronization signal is most recently received and a backlight compensation coefficient calculation time;
obtaining an image frame to be displayed and determining a pixel signal characteristic of the image frame to be displayed;
calculating a backlight compensation coefficient corresponding to the image frame to be displayed based on the frame refresh rate, the pixel signal characteristic and a backlight setting parameter of the display device;
controlling the brightness of the backlight when the image frame to be displayed is displayed on the display device based on the backlight compensation coefficient.

According to an embodiment of the present disclosure, a backlight brightness control device is disclosed. The backlight brightness control device comprises:
a frame refresh rate calculation unit, configured to calculate a frame refresh rate of a display device in a time interval between a time when the frame synchronization signal is most recently received and a backlight compensation coefficient calculation time;
a pixel signal characteristic determination unit, configured to obtain an image frame to be displayed and determining a pixel signal characteristic of the image frame to be displayed;
a backlight compensation coefficient calculation unit, configured to calculate a backlight compensation coefficient corresponding to the image frame to be displayed based on the frame refresh rate, the pixel signal characteristic and a backlight setting parameter of the display device;
a backlight brightness control unit, configured to control the brightness of the backlight when the image frame to be displayed is displayed on the display device based on the backlight compensation coefficient.

Optionally, the frame refresh rate calculation unit is configured to: obtain a frame synchronization signal and setting a number of signal receptions corresponding to a backlight refresh synchronization signal to 0 in response to the frame synchronization signal, where a frequency of the backlight refresh synchronization signal is greater than a frequency of the frame synchronization signal;
receive the backlight refresh synchronization signal and increasing the number of signal receptions by 1 according to the backlight refreshing synchronization signal;
return to perform the step of receiving the backlight refresh synchronization signal until the backlight compensation coefficient calculation time;
determine a current number of signal receptions at the backlight compensation coefficient calculation time, and calculate the frame refresh rate of the display device in the time interval between the time when the frame synchronization signal is most recently received and the backlight compensation coefficient calculation time according to the current number of signal receptions and a backlight refresh frequency of the display device.

Optionally, the pixel signal characteristic determination unit is configured to obtain the image frame to be displayed and counting a number of pixels corresponding to the image frame to be displayed in a preset pixel value interval;
calculate the pixel signal characteristic of the image frame to be displayed based on the number of pixels corresponding to the image frame to be displayed in each pixel value interval.

Optionally, the pixel number statistics unit is configured to calculate a pixel signal average value corresponding to the image frame to be displayed in a preset statistical interval and a proportion of the number of pixels corresponding to each statistical interval based on the number of pixels corresponding to the image frame to be displayed in each pixel value interval;
the pixel signal feature calculation unit is configured to determine a pixel signal adjustment coefficient corresponding to the pixel signal average value from a preset adjustment coefficient mapping relationship based on the pixel signal average value and the proportion of the number of pixels;
perform a weighted calculation according to each pixel signal average value and a pixel signal adjustment coefficient corresponding to each pixel signal average value to obtain the pixel signal characteristics of the image frame to be displayed.

Optionally, the backlight compensation coefficient calculation unit is configured to obtain a first brightness data set corresponding to the display device, wherein the first brightness data set comprises at least a group of candidate pixel signal values and corresponding brightness data under a candidate frame refresh rate; and
a backlight compensation coefficient calculation subunit, configured to determine target brightness data under the frame refresh rate and the pixel signal characteristic from the first brightness data set according to the frame refresh rate and the pixel signal characteristics;
calculate the backlight compensation coefficient corresponding to the image frame to be displayed based on the backlight setting parameter of the display device and the target brightness data.

Optionally, the first luminance data set acquisition unit is configured to: utilize the control signal source to output a preset candidate pixel signal value through the display device under a preset candidate frame refresh rate, wherein the candidate frame refresh rate is a value within a preset frame refresh rate range, and the candidate pixel signal value is a value within a preset pixel signal value range;
obtain the brightness data of the display device under the candidate frame refresh rate and the candidate pixel signal value;
modify the candidate frame refresh rate and the candidate pixel signal value to obtain a new preset candidate frame refresh rate and a new preset candidate pixel signal value;
return to the operation of performing a signal source controlling the display device to output the preset candidate pixel signal values at the preset candidate frame refresh rate, until obtaining the first brightness data of the display device under the output of each candidate pixel signal value in the range of each candidate frame in the frame refresh rate range, and generating a first brightness data set corresponding to the display device.

Optionally, the backlight compensation coefficient calculation subunit is configured to: determine a brightness change interval corresponding to the backlight setting parameter from a preset brightness curve based on the backlight setting parameter of the display device, and calculate a curve slope of the brightness change interval;
obtain a target brightness adjustment interval corresponding to the brightness change interval according to a ratio of the target brightness data and the curve slope;
calculate the brightness adjustment value under at least one preset adjustment step for the target brightness adjustment interval;
determine the target brightness adjustment value satisfying a brightness condition from the brightness adjustment value under each adjustment step based on the target brightness data;
take the adjustment step corresponding to the target brightness adjustment value as the backlight compensation coefficient corresponding to the image frame to be displayed.

Optionally, the backlight brightness control device provided in the embodiment of the present disclosure further comprises a brightness curve generating unit configured to control the signal source of the display device to output a preset pixel signal value under a candidate backlight setting parameter within a range of the preset backlight setting parameter;
obtain the brightness data of the display device under the candidate frame refresh rate and the pixel signal value;
modify the candidate frame refresh rate to obtain a new preset candidate frame refresh rate;
return to the step of performing the signal source of the control display device to output the preset pixel signal value under the preset candidate backlight setting parameters, until the second brightness data of the display device is obtained under each candidate backlight setting parameter in the backlight setting parameter range;
generate a brightness curve based on the second brightness data.

Correspondingly, an embodiment of the present disclosure provides an electronic device which includes a processor and a memory storing an application executable by the processor to perform the method as provided in the embodiments of the present disclosure.

Correspondingly, an embodiment of the present disclosure provides a computer-readable storage medium storing a plurality of instructions executable by the processor to perform the method as provided in the embodiments of the present disclosure.

In addition, another embodiment of the present disclosure provides a computer program product comprising computer program or instructions executable by the processor to perform the method as provided in the embodiments of the present disclosure.

### Advantageous Effect of the Present Disclosure

### Beneficial Effects

Embodiments of the present disclosure propose calculating a frame refresh rate of a display device in a time interval between a time when the frame synchronization signal is most recently received and a backlight compensation coefficient calculation time; obtaining an image frame to be displayed and determining a pixel signal characteristic of the image frame to be displayed; calculating a backlight compensation coefficient corresponding to the image frame to be displayed based on the frame refresh rate, the pixel signal characteristic and a backlight setting parameter of the display device; controlling the brightness of the backlight when the image frame to be displayed is displayed on the display device based on the backlight compensation coefficient. When the backlight compensation coefficient is calculated each time, the real-time frame refresh rate from the frame synchronization signal has been received last time to now is calculated, and the pixel signal characteristic is corresponding to the image frame to be displayed. The backlight compensation coefficient is calculated based on the real-time frame refresh rate, the pixel signal characteristic and the backlight setting parameter. Therefore, the backlight brightness of the display device can be compensated in real time, so that the display device can have a stable brightness when the VRR technology is applied, and the user's visual experience is improved.

### BRIEF DESCRIPTION OF THE DRAWINGS

### Description of the Drawings

In order to more clearly illustrate the technical solutions in the embodiments of the present disclosure, the drawings required to be used in the description of the embodiments will be briefly introduced below, and it is obvious that the drawings described below are only some embodiments of the present disclosure, and for those skilled in the art, other drawings can be acquired according to these drawings without creative labor.

FIG. 1 is a diagram of a scene of a backlight brightness control method according to an embodiment of the present disclosure.

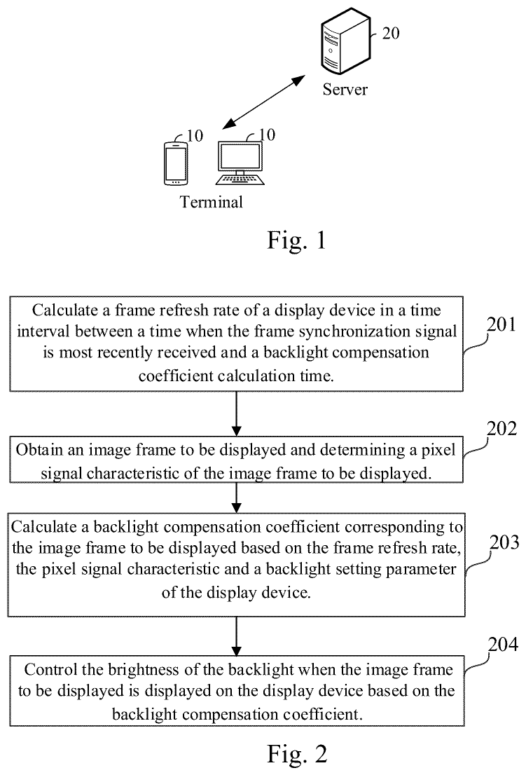

FIG. 2 is a flow chart of the backlight brightness control method according to an embodiment of the present disclosure.

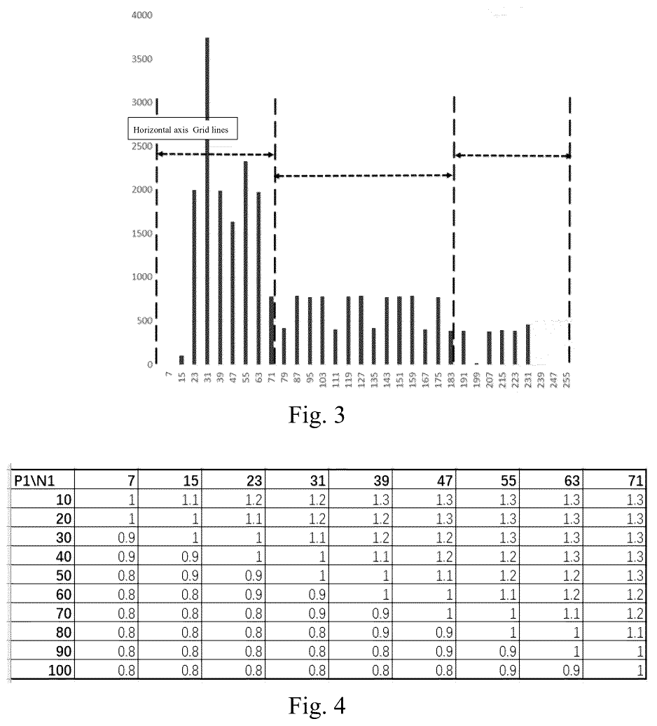

FIG. 3 is a diagram of a statistical result after performing a statistical calculation on a number of pixels in each pixel value interval according to an embodiment of the present disclosure.

FIG. 4 is a diagram of a mapping relationship of adjustment coefficients according to an embodiment of the present disclosure.

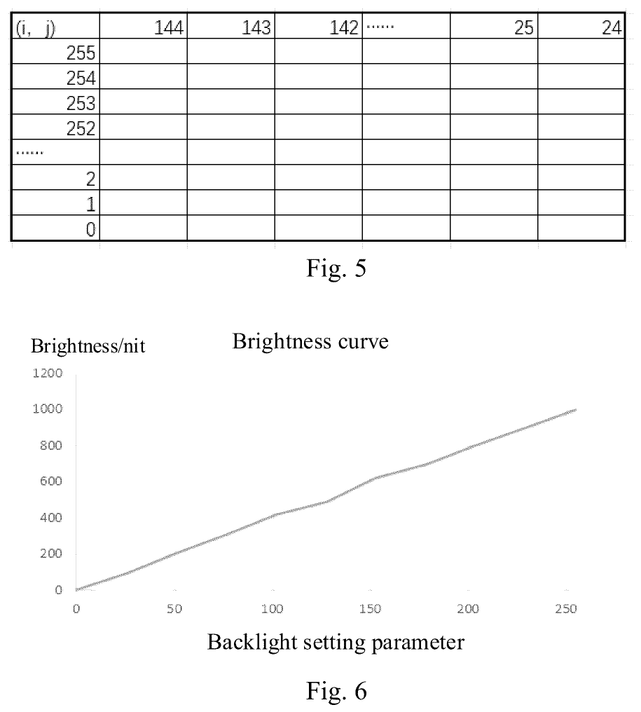

FIG. 5 is a diagram of the first brightness data set according to an embodiment of the present disclosure.

FIG. 6 is a diagram of a brightness curve according to an embodiment of the present disclosure.

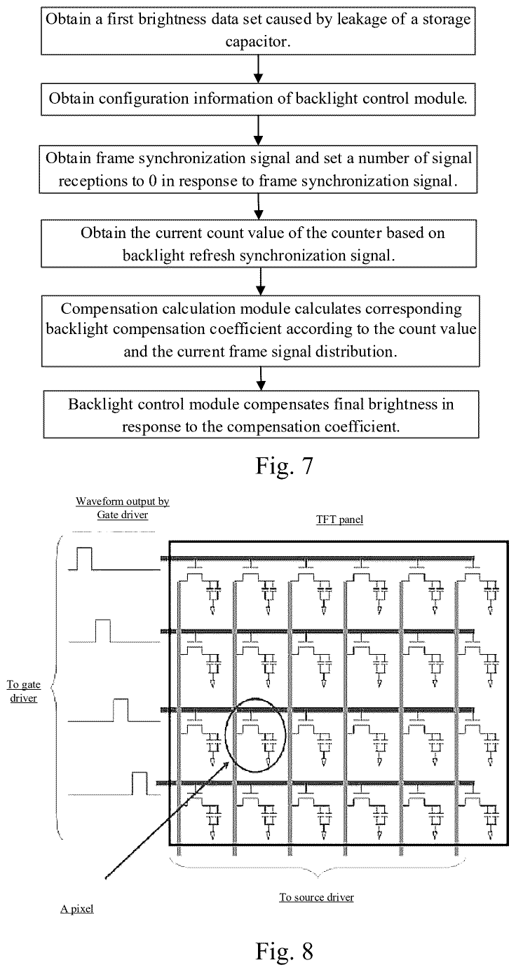

FIG. 7 is a flow chart of the backlight brightness control method according to another embodiment of the present disclosure.

FIG. 8 is a schematic diagram of a liquid crystal display equivalent driving circuit according to an embodiment of the present disclosure.

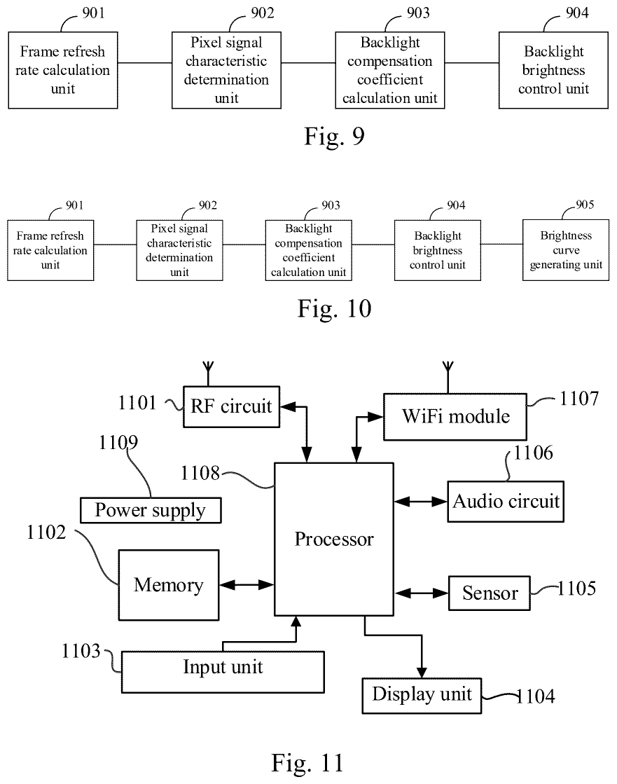

FIG. 9 is a diagram of a backlight brightness control device according to an embodiment of the present disclosure.

FIG. 10 is a diagram of the backlight brightness control device according to another embodiment of the present disclosure.

FIG. 11 is a block diagram of the electronics device according to another embodiment of the present disclosure.

### DETAILED DESCRIPTION OF THE PRESENT DISCLOSURE

### Embodiments of Present Disclosure

The technical solutions in the embodiments of the present disclosure will be clearly and completely described below in conjunction with the accompanying drawings in the embodiments of the present disclosure, and it is obvious that the described embodiments are only part of the embodiments of the present disclosure, not all embodiments. Based on the embodiments in the present disclosure, all other embodiments obtained by a person skilled in the art without creative work fall within the scope of protection of the present disclosure.

An embodiment of the present disclosure provides a backlight brightness control method, backlight brightness control device, electronic device, and computer-readable storage medium. Specifically, the embodiment of the present disclosure provides a backlight brightness control method suitable for a backlight brightness control device, and the backlight brightness control device may be integrated in an electronic device.

The electronic device may be a terminal and other equipment, including but not limited to mobile devices and fixed devices, such as mobile terminals, including but not limited to smart phones, smart watches, tablet computers, laptops, smart cars, where fixed devices include but are not limited to desktop computers, smart TVs, etc.

The electronic device can also be a server and other equipment. The server can be an independent physical server, or a server cluster or distributed system composed of multiple physical servers, or it can provide cloud services, cloud databases, cloud computing, cloud functions, cloud storage, network services, cloud communications, middleware services, domain name services, security services, Content Delivery Network (CDN), and cloud servers for basic cloud computing services such as big data and artificial intelligence platforms, but not limited to them.

The backlight brightness control method of the embodiment of the present disclosure can be realized by a server, and can also be jointly realized by a terminal and a server.

The following takes the backlight brightness control method jointly implemented by the terminal and the server as an example to illustrate the method.

As shown in FIG. 1, a backlight brightness control system is disclosed. The backlight brightness control system comprises a terminal 10 and a server 20. The terminal 10 is connected to the server 20 through a network, such as a wired or wireless network connection. Here, the server 20 can be implemented as an electronic device that sends data to be displayed to the terminal 10.

The server 20 can be used to send an image frame to be displayed to the terminal 10.

The terminal 20 can be used for calculating a frame refresh rate of a display device in a time interval between a time when the frame synchronization signal is most recently received and a backlight compensation coefficient calculation time; obtaining an image frame to be displayed and determining a pixel signal characteristic of the image frame to be displayed; and calculating a backlight compensation coefficient corresponding to the image frame to be displayed based on the frame refresh rate, the pixel signal characteristic and a backlight setting parameter of the display device.

The terminal 10 is further used for controlling the brightness of the backlight when the image frame to be displayed is displayed on the display device based on the backlight compensation coefficient.

In other embodiments, the step of calculating the backlight compensation coefficient corresponding to the image frame to be displayed performed by the terminal 10 may alternatively be performed by the server 20. For example, the server 20 can send the backlight compensation coefficient to the terminal 10 after calculating the backlight compensation coefficient corresponding to the image frame to be displayed, so that the terminal 10 controls the backlight brightness of the image frame to be displayed on the display device based on the backlight compensation coefficient.

Each of them is explained in detail below. It should be noted that the following embodiments are not used as a limitation on the preferred order of embodiments.

An embodiment of the present disclosure will be described from the perspective of a backlight brightness control device, which can be specifically integrated in a server or a terminal.

As shown in FIG. 2, the flow of the backlight brightness control method in this embodiment is as follows:
201: calculating a frame refresh rate of a display device in a time interval between a time when the frame synchronization signal is most recently received and a backlight compensation coefficient calculation time.

The frame synchronization signal is a signal that the display device can receive regularly or irregularly to avoid the loss of alignment in the image frame received by the display device.

Generally, the frame synchronization signal is sent to the display device at a fixed frequency.

Specifically, the display device is an electronic device with a display function, such as a TV, a tablet, a laptop, a smart phone, a smart watch, a smart car, etc.

The backlight compensation coefficient calculation time is the time when the corresponding backlight compensation coefficient needs to be calculated for the image frame to be displayed. This time moment can be the moment when the image frame to be displayed is received, the moment when the image frame to be displayed is about to bed is played, and/or so on.

The frame refresh rate can be the average number of times the display device refreshes an image frame per second in a time interval.

Specifically, the frame refresh rate can be calculated according to the number of times the display device refreshes the image frame in the time interval. That is, the step of calculating a frame refresh rate of a display device in a time interval between a time when the frame synchronization signal is most recently received and a backlight compensation coefficient calculation time, may comprise:
obtaining a frame synchronization signal and setting a number of signal receptions corresponding to a backlight refresh synchronization signal to 0 in response to the frame synchronization signal, wherein a frequency of the backlight refresh synchronization signal is greater than a frequency of the frame synchronization signal;
receiving the backlight refresh synchronization signal and increasing the number of signal receptions by 1 according to the backlight refreshing synchronization signal;
returning to perform the step of receiving the backlight refresh synchronization signal until the backlight compensation coefficient calculation time; and
determining a current number of signal receptions at the backlight compensation coefficient calculation time, and calculating the frame refresh rate of the display device in the time interval between the time when the frame synchronization signal is most recently received and the backlight compensation coefficient calculation time according to the current number of signal receptions and a backlight refresh frequency of the display device.

The backlight refresh synchronization signal is the signal that the display device receives every time it needs to refresh an image frame. That is, every time it receives a backlight refresh sync signal, the display device displays an image frame.

In general, the refresh frequency of the backlight refresh synchronization signal is 240 Hz and above, which is much higher than the frequency of the frame synchronization signal.

Optionally, the number of signal receptions can be recorded via a preset counter, etc.

When the frame synchronization signal is obtained, the number of signal receptions count can be reset to zero and then added by 1 every time when the synchronization signal is received. Each time the backlight refresh synchronization signal is received, the number of signal receptions increases by 1.

When the frame refresh rate is calculated, the duration from the previous frame synchronization signal can be calculated according to the current backlight refresh rate of the display device f_BL and the number of signal receptions count (t1=1/f_BL*count).

The equivalent frame refresh rate f1 is calculated, which reflects the equivalent frame refresh rate since the previous frame synchronization signal was triggered. Assuming that the next frame synchronization signal arrives immediately, and the corresponding frame refresh rate f1=1/t1.

Specifically, the frame refresh rate f1 can be calculated by calculating the average value of the backlight refresh rate f_BL in the time interval according to the backlight refresh rate f_BL and its duration tc of each backlight refresh rate. The equation is f1=(f_BL1*tc1+f_BL2*tc2+ . . . +f_BLn*tcn)/(tc1+tc2+ . . . +tcn).
202: obtaining an image frame to be displayed and determining a pixel signal characteristic of the image frame to be displayed.

In an embodiment of the present disclosure, the image frame to be displayed may be an image composed of information to be displayed in a display screen. For example, an image frame to be displayed can be a video frame of a picture or video to be played in the display, or an image frame to be displayed can be an image frame including an application interface and the default background of the display.

The pixel signal characteristic can be data obtained by performing a statistically process based on the pixel signal corresponding to each pixel in the image frame to be displayed.

Specifically, the pixel signal can be understood as the pixel color signal corresponding to each pixel. Specifically, the pixel signal can be represented by RGB color space, YUV color space, YIQ color space, and other modes.

In some embodiments, a pixel signal characteristic that can reflect the characteristic of the image frame to be displayed can be obtained according to the signal distribution of the image frame to be displayed. That is, the step 202 may comprise:
obtaining the image frame to be displayed and counting a number of pixels corresponding to the image frame to be displayed in a preset pixel value interval; and
calculating the pixel signal characteristic of the image frame to be displayed based on the number of pixels corresponding to the image frame to be displayed in each pixel value interval.

The pixel value interval can be obtained by dividing the pixel value into intervals. For example, if the image frame to be displayed is expressed through RGB color space, the pixel value interval from 0 to 255 can be divided into 32 intervals, including [0,7], [8,15], [16,23], . . . , [248,255].

Optionally, the step “calculating the pixel signal characteristic of the image frame to be displayed based on the number of pixels corresponding to the image frame to be displayed in each pixel value interval”may include:
calculating a pixel signal average value corresponding to the image frame to be displayed in a preset statistical interval and a proportion of the number of pixels corresponding to each statistical interval based on the number of pixels corresponding to the image frame to be displayed in each pixel value interval;
determining a pixel signal adjustment coefficient corresponding to the pixel signal average value from a preset adjustment coefficient mapping relationship based on the pixel signal average value and the proportion of the number of pixels; and
performing a weighted calculation according to each pixel signal average value and a pixel signal adjustment coefficient corresponding to each pixel signal average value to obtain the pixel signal characteristics of the image frame to be displayed.

As shown in FIG. 3, the number of pixels corresponding to each pixel value interval can be counted in advance.

The statistical interval is obtained by further dividing the pixel value interval. For example, the pixel value interval can be further divided into three statistical intervals. For example, the first statistical interval corresponds to 9 pixel value intervals, i.e., [0,71]. The second statistical interval includes 14 pixel value intervals, i.e., [72,183]. The third statistical interval includes 9 pixel value intervals, i.e., [184,255].

Specifically, the pixel signal average value can be calculated based on the number of pixels in the statistical interval or the pixel value interval.

Taking the pixel signal average values in the three statistical intervals as N1, N2, and N3 as an example. N1=(po(1)*po_n(1)+po(2)*po_n(2)+ . . . +po(9)*po_n(9))/(po_n(1)+po_n(2)+ . . . +po_n(9)); N2=(po(10)*po_n(10)+po(11)*po_n(11)+ . . . +po(23)*po_n(23)/(po_n(10)+po_n(11)+ . . . +po_n(23); N3=(po(24)*po_n(24)+po(25)*po_n(25)+ . . . +po(32)*po_n(32)/(po_n(24)+po_n(25)+ . . . po_n(32).

Here, po_n(i) represents the number of pixels in the statistical interval or the pixel value interval, and po(i) can represent the maximum value of each pixel value interval. For example, po(i) can be 7, 15, . . . , 247, 255 respectively.

Specifically, the proportion of the number of pixels can be calculated based on the number of pixels in the statistical interval or the pixel value interval.

Taking the pixel signal average values in the three statistical intervals as P1, P2, and P3 as an example. P1=(po_n(1)+po_n(2)+ . . . po_n(9))/((po_n(1)+po_n(2)+ . . . po_n(32)))*100; P2=(po_n(10)+po_n(11)+ . . . po_n(23)/((po_n(1)+po_n(2)+ . . . po_n(32)))*100; P3=(po_n(24)+po_n(25)+ . . . po_n(32)/((po_n(1)+po_n(2)+ . . . po_n(32)))*100.

The adjustment coefficient mapping relationship is the correspondence relationship between the adjustment coefficient and the pixel signal average value and the proportion of the number of pixels. That is, a set of the pixel signal average value and the proportion of the number of pixels corresponds an adjustment coefficient.

For example, P1 and N1 are used as indexes, and the corresponding adjustment coefficients A1 can be found in the adjustment coefficient mapping LUT_1 shown in FIG. 4. Similarly, P2, N2, P3, and N3 can be used to find corresponding adjustment coefficients A2 and A3 in the adjustment coefficient mapping relationships LUT2 and LUT3, respectively.

According to the adjustment coefficient and the pixel signal average value, the pixel signal characteristic S1 can be calculated. The equation is as follows:

S1=N1*A1+N2*A2+N3*A3

In some embodiments, P1, P2, P3 and N1, N2, N3 can be directly involved in the calculation of index and/or pixel signal characteristics. In other embodiments, P1, P2, P3 and N1, N2, N3 can be converted to facilitate subsequent calculations.

For example, N1, N2, and N3 are divided into the same signal interval. If N1=5, then it falls to the interval [0,7], so N1 will be converted to 7. The intervals of P1, P2, and P3 are distanced by 10. If P1=23, it falls into the interval [20,30], so P1 will be converted to 30.

Alternatively, the step “calculating the pixel signal characteristic of the image frame to be displayed based on the number of pixels corresponding to the image frame to be displayed in each pixel value interval” may be directly calculating for the pixel value intervals. For example, S1=(po(1)*po_n(1) +po(2)*po_n(2)+ . . . +po(32)*po_n(32))/(po_n(1)+po_n(2)+ . . . po_n(32)).
203: calculating a backlight compensation coefficient corresponding to the image frame to be displayed based on the frame refresh rate, the pixel signal characteristic and a backlight setting parameter of the display device.

The backlight setting parameter is the parameter currently set by the display device for the backlight function. The backlight setting parameter can be set by the user or the technician according to the actual needs, and these changes fall within the scope of the present disclosure.

In some embodiments, the step 203 may comprise:
obtaining a first brightness data set corresponding to the display device, wherein the first brightness data set comprises at least a group of candidate pixel signal values and corresponding brightness data under a candidate frame refresh rate;
determining target brightness data under the frame refresh rate and the pixel signal characteristic from the first brightness data set according to the frame refresh rate and the pixel signal characteristics; and
calculating the backlight compensation coefficient corresponding to the image frame to be displayed based on the backlight setting parameter of the display device and the target brightness data.

The first brightness data set can be the set of brightness loss data caused by the leakage of the storage capacitor, which can be expressed as L(i,j). The first brightness data set can be shown in FIG. 5. The first brightness data set can be stored in the software of the display device in the form of configuration items and then directly loaded without multiple calculations.

Specifically, the step “calculating the backlight compensation coefficient corresponding to the image frame to be displayed based on the backlight setting parameter of the display device and the target brightness data” may comprise:
determining a brightness change interval corresponding to the backlight setting parameter from a preset brightness curve based on the backlight setting parameter of the display device, and calculating a curve slope of the brightness change interval
obtaining a target brightness adjustment interval corresponding to the brightness change interval according to a ratio of the target brightness data and the curve slope;
for the target brightness adjustment interval, calculating the brightness adjustment value under at least one preset adjustment step;
determining the target brightness adjustment value satisfying a brightness condition from the brightness adjustment value under each adjustment step based on the target brightness data; and
taking the adjustment step corresponding to the target brightness adjustment value as the backlight compensation coefficient corresponding to the image frame to be displayed.

For example, the brightness curve can be as shown in FIG. 6. Under the condition that the current backlight setting parameter BL keeps unchanged, the display device is in an interval LC_Q of the brightness curve LC. For example, the interval can be between ±5 of the BL value.

Further, the slope k1 of the brightness curve corresponding to the interval LC_Q can be calculated. The approximate adjustment range, i.e. the target brightness adjustment interval, can be determined according to the slope and the brightness loss value L(S1,f1). For example, the target brightness adjustment interval can be [BL, BL+LS+3].

The slope of the curve k1 can be the slope calculated from the two endpoints of the interval LC_Q.

In the interval [BL, BL+LS+3], the cumulative growth LA_i corresponding to each adjustment step is calculated. The closest value in the LA_i is looked up according to L(S1,f1), and the corresponding adjustment step size is the corresponding backlight compensation coefficient B1.
204: controlling the brightness of the backlight when the image frame to be displayed is displayed on the display device based on the backlight compensation coefficient.

As shown in FIG. 7, a compensation calculation module can be arranged in the display device for calculating the backlight compensation coefficient. The backlight control module can be arranged in the display device to control the final brightness for displaying the image frame to be displayed.

When the display device switches between high and low refresh rates or is in the working state of low refresh rate for a long time, the corresponding driving voltage of each pixel in the equivalent driving circuit of the display device is refreshed once under the synchronization signal of each frame and is stored by its equivalent capacitance after refreshing. However, the equivalent capacitance has leakage, and thus the driving voltage will be affected. On the basis of the backlight parameter of the display device keeps unchanged, the light transmitted by the display device will be affected, resulting in the decrease in the display brightness.

Different refresh rates correspond to different capacitor leakage, and thus correspond to different brightness of the display device. That is, the brightness jump problem will occur. As shown in FIG. 8. FIG. 8 is diagram of the equivalent driving circuit of the liquid crystal display according to an embodiment of the present disclosure.

Optionally, the first brightness data set can be collected in advance and directly obtained when needed. Or, the first brightness data set can be acquired in real time each time, and the step “obtaining the first brightness data set corresponding to the display device” may comprise:
utilizing the control signal source to output a preset candidate pixel signal value through the display device under a preset candidate frame refresh rate, wherein the candidate frame refresh rate is a value within a preset frame refresh rate range, and the candidate pixel signal value is a value within a preset pixel signal value range;
obtaining the brightness data of the display device under the candidate frame refresh rate and the candidate pixel signal value;
modifying the candidate frame refresh rate and the candidate pixel signal value to obtain a new preset candidate frame refresh rate and a new preset candidate pixel signal value;
returning to the step of performing a signal source controlling the display device to output the preset candidate pixel signal values at the preset candidate frame refresh rate, until obtaining the first brightness data of the display device under the output of each candidate pixel signal value in the range of each candidate frame in the frame refresh rate range, and generating a first brightness data set corresponding to the display device.

For example, the VRR function of the LCD can be turned on and the signal source with variable refresh rate can be connected to the display. Then, the brightness meter can be put in the middle of the screen with its probe contacting the screen. The signal source is controlled to output a full-screen grayscale signal, and the signal amplitude value is i, and the value range of i is [0,255]. The refresh rate of the control signal source is j. In order to ensure the continuous effect during video playback, j is generally greater than 24. For example, the value range of j can be [24,144].

The brightness meter is used to collect the corresponding brightness signal L, which is recorded as L(i,j). Then, it determines whether j exceeds the lower limit, If so, then it determines whether i exceeds the lower limit and jump out of the loop if i exceeds the lower limit. Otherwise, the value of i decreases and returns to the step of controlling the control signal source to output a full-screen grayscale signal.

FIG. 8 shows an example of the first brightness data set. As shown in FIG. 8, a set of (i,j) can correspond to a brightness signal L(i,j).

Optionally, the brightness curve can be generated in advance and directly obtained when needed. Or, the first brightness data set can be generated in real time each time. The backlight brightness control method further comprises following steps before the step “determining the brightness change interval corresponding to the backlight setting parameter from a preset brightness curve”:
controlling the signal source of the display device to output a preset pixel signal value under a preset candidate backlight setting parameter, wherein the candidate backlight setting parameter is a value within a preset backlight setting parameter range;
obtaining the brightness data of the display device under the candidate frame refresh rate and the pixel signal value;
modifying the candidate frame refresh rate to obtain a new preset candidate frame refresh rate;
returning to the step of controlling the signal source of the display device to output a preset pixel signal value under a preset candidate backlight setting parameter, until second brightness data of the display device under each candidate backlight setting parameter in the backlight setting parameter range is obtained; and
generating the brightness curve based on the second brightness data.

Similarly, the corresponding brightness data is collected by a photometer. But in this step, the output signal keeps the full-screen grayscale signal with an unchanged signal amplitude of 255. Then, the backlight control value is incremented from 0 to 2\hat{ }bit in turn and the corresponding brightness value is collected separately. FIG. 4 shows a conversion curve with an 8-bit control accuracy.

In summary, the embodiment of the present disclosure propose calculating a frame refresh rate of a display device in a time interval between a time when the frame synchronization signal is most recently received and a backlight compensation coefficient calculation time; obtaining an image frame to be displayed and determining a pixel signal characteristic of the image frame to be displayed; calculating a backlight compensation coefficient corresponding to the image frame to be displayed based on the frame refresh rate, the pixel signal characteristic and a backlight setting parameter of the display device; controlling the brightness of the backlight when the image frame to be displayed is displayed on the display device based on the backlight compensation coefficient. When the backlight compensation coefficient is calculated each time, the real-time frame refresh rate from the frame synchronization signal has been received last time to now is calculated, and the pixel signal characteristic is corresponding to the image frame to be displayed. The backlight compensation coefficient is calculated based on the real-time frame refresh rate, the pixel signal characteristic and the backlight setting parameter. Therefore, the backlight brightness of the display device can be compensated in real time, so that the display device can have a stable brightness when the VRR technology is applied, and the user's visual experience is improved.

In order to better implement the above method, a backlight brightness control device is disclosed according to an embodiment of the present disclosure.

Please refer to FIG. 9, the backlight brightness control device comprises:
a frame refresh rate calculation unit 901, configured to calculate a frame refresh rate of a display device in a time interval between a time when the frame synchronization signal is most recently received and a backlight compensation coefficient calculation time;
a pixel signal characteristic determination unit 902, configured to obtain an image frame to be displayed and determining a pixel signal characteristic of the image frame to be displayed;
a backlight compensation coefficient calculation unit 903, configured to calculate a backlight compensation coefficient corresponding to the image frame to be displayed based on the frame refresh rate, the pixel signal characteristic and a backlight setting parameter of the display device; and
a backlight brightness control unit 904, configured to control the brightness of the backlight when the image frame to be displayed is displayed on the display device based on the backlight compensation coefficient.

In an embodiment of the present disclosure, the frame refresh rate calculation unit 901 is configured to: obtain a frame synchronization signal and setting a number of signal receptions corresponding to a backlight refresh synchronization signal to 0 in response to the frame synchronization signal, wherein a frequency of the backlight refresh synchronization signal is greater than a frequency of the frame synchronization signal;
receive the backlight refresh synchronization signal and increasing the number of signal receptions by 1 according to the backlight refreshing synchronization signal;
return to perform the step of receiving the backlight refresh synchronization signal until the backlight compensation coefficient calculation time;
determine a current number of signal receptions at the backlight compensation coefficient calculation time, and calculate the frame refresh rate of the display device in the time interval between the time when the frame synchronization signal is most recently received and the backlight compensation coefficient calculation time according to the current number of signal receptions and a backlight refresh frequency of the display device.

In some optional embodiments, the pixel signal characteristic determination unit 902 is configured to obtain the image frame to be displayed and counting a number of pixels corresponding to the image frame to be displayed in a preset pixel value interval;
calculate the pixel signal characteristic of the image frame to be displayed based on the number of pixels corresponding to the image frame to be displayed in each pixel value interval.

In some optional embodiments, the pixel signal characteristic determination unit 902 is configured to calculate a pixel signal average value corresponding to the image frame to be displayed in a preset statistical interval and a proportion of the number of pixels corresponding to each statistical interval based on the number of pixels corresponding to the image frame to be displayed in each pixel value interval;
the pixel signal feature calculation unit is configured to determine a pixel signal adjustment coefficient corresponding to the pixel signal average value from a preset adjustment coefficient mapping relationship based on the pixel signal average value and the proportion of the number of pixels;
perform a weighted calculation according to each pixel signal average value and a pixel signal adjustment coefficient corresponding to each pixel signal average value to obtain the pixel signal characteristics of the image frame to be displayed.

In some optional embodiments, the backlight compensation coefficient calculation unit 903 is configured to: obtain a first brightness data set corresponding to the display device, where the first brightness data set comprises at least a group of candidate pixel signal values and corresponding brightness data under a candidate frame refresh rate;
determine target brightness data under the frame refresh rate and the pixel signal characteristic from the first brightness data set according to the frame refresh rate and the pixel signal characteristics;
calculate the backlight compensation coefficient corresponding to the image frame to be displayed based on the backlight setting parameter of the display device and the target brightness data.

In some optional embodiments, the backlight compensation coefficient calculation unit 903 is configured to: utilize the control signal source to output a preset candidate pixel signal value through the display device under a preset candidate frame refresh rate, wherein the candidate frame refresh rate is a value within a preset frame refresh rate range, and the candidate pixel signal value is a value within a preset pixel signal value range;
obtain the brightness data of the display device under the candidate frame refresh rate and the candidate pixel signal value;
modify the candidate frame refresh rate and the candidate pixel signal value to obtain a new preset candidate frame refresh rate and a new preset candidate pixel signal value;
return to the operation of performing a signal source controlling the display device to output the preset candidate pixel signal values at the preset candidate frame refresh rate, until obtaining the first brightness data of the display device under the output of each candidate pixel signal value in the range of each candidate frame in the frame refresh rate range, and generating a first brightness data set corresponding to the display device.

In some optional embodiments, the backlight compensation coefficient calculation unit 903 is configured to: determine a brightness change interval corresponding to the backlight setting parameter from a preset brightness curve based on the backlight setting parameter of the display device, and calculate a curve slope of the brightness change interval;
obtain a target brightness adjustment interval corresponding to the brightness change interval according to a ratio of the target brightness data and the curve slope;
calculate the brightness adjustment value under at least one preset adjustment step for the target brightness adjustment interval;
determine the target brightness adjustment value satisfying a brightness condition from the brightness adjustment value under each adjustment step based on the target brightness data;
take the adjustment step corresponding to the target brightness adjustment value as the backlight compensation coefficient corresponding to the image frame to be displayed.

In some optional embodiments, the backlight brightness control device provided in the embodiment of the present disclosure further comprises a brightness curve generating unit 905 configured to control the signal source of the display device to output a preset pixel signal value under a candidate backlight setting parameter within a range of the preset backlight setting parameter;
obtain the brightness data of the display device under the candidate frame refresh rate and the pixel signal value;
modify the candidate frame refresh rate to obtain a new preset candidate frame refresh rate;
return to the step of performing the signal source of the control display device to output the preset pixel signal value under the preset candidate backlight setting parameters, until the second brightness data of the display device is obtained under each candidate backlight setting parameter in the backlight setting parameter range;
generate a brightness curve based on the second brightness data.

Embodiments of the present disclosure propose a backlight brightness control device configured for calculating a frame refresh rate of a display device in a time interval between a time when the frame synchronization signal is most recently received and a backlight compensation coefficient calculation time; obtaining an image frame to be displayed and determining a pixel signal characteristic of the image frame to be displayed; calculating a backlight compensation coefficient corresponding to the image frame to be displayed based on the frame refresh rate, the pixel signal characteristic and a backlight setting parameter of the display device; controlling the brightness of the backlight when the image frame to be displayed is displayed on the display device based on the backlight compensation coefficient. When the backlight compensation coefficient is calculated each time, the real-time frame refresh rate from the frame synchronization signal has been received last time to now is calculated, and the pixel signal characteristic is corresponding to the image frame to be displayed. The backlight compensation coefficient is calculated based on the real-time frame refresh rate, the pixel signal characteristic and the backlight setting parameter. Therefore, the backlight brightness of the display device can be compensated in real time, so that the display device can have a stable brightness when the VRR technology is applied, and the user's visual experience is improved.

In addition, the embodiment of the present disclosure also provides an electronic device. The electronic device can be a terminal or a server. Please refer to FIG. 11 illustrating a schematic diagram of an electronic device according to an embodiment of the present disclosure.

The electronic device may comprise a radio frequency (RF) circuit 1101, a memory 1102 including one or more (only one is shown in the figure) computer-readable storage media, an input unit 1103, a display unit 1104, a sensor 1105, an audio circuit 1106, a wireless Fidelity (WiFi) module 1107, a processor 1108 including one or more (only one is shown in the figure) processing cores, and a power supply 1109, etc. Those skilled in the art would understand that the electronic device is not limited to the structure of the electronic device shown in FIG. 11. The electronic device may comprise more or less components than those illustrated in the figure, or some components may be combined, or the electronic device may have different component arrangements.

The RF circuit 1101 may be configured to receive and send a signal during an information receiving and sending process or a conversation process. Specifically, after receiving downlink information from a base station, the RF circuit 1101 delivers the downlink information to one or more processors 180 for processing, and sends related uplink data to the base station. Generally, the RF circuit 1101 includes, but is not limited to, an antenna, at least one amplifier, a tuner, one or more oscillators, a subscriber identity module (SIM) card, a transceiver, a coupler, a low noise amplifier (LNA), and a duplexer. In addition, the RF circuit 1101 may also communicate with a network and another device by wireless communication. The wireless communication may use any communications standard or protocol, which includes, but is not limited to, Global System of Mobile Communication (GSM), General Packet Radio Service (GPRS), Code Division Multiple Access (CDMA), Wideband Code Division Multiple Access (WCDMA, Wideband Code Division Multiple Access), Long Term Evolution (LTE), E-mail, Short Messaging Service (SMS), etc.

The memory 1102 may be configured to store a software program and module. The processor 1108 runs the software program and module stored in the memory 1102, to implement various functional applications and data processing. The memory 1102 may mainly include a program storage area and a data storage area. The program storage area may store an operating system, an application program required by at least one function (such as a sound playback function and an image display function), and the like. The data storage area may store data (such as audio data and an address book) created according to use of the electronic device, and the like. In addition, the memory 1102 may include a high speed random access memory, and may also include a non-volatile memory, such as at least one magnetic disk storage device, a flash memory device, or another volatile solid-state storage device. Correspondingly, the memory 1102 may further include a memory controller, so that the processor 1108 and the input unit 1103 access the memory 1102.

The input unit 1103 may be configured to receive input digit or character information, and generate keyboard, mouse, joystick, optical, or track ball signal input related to the user setting and function control. Specifically, the input unit 1103 may include a touch-sensitive surface and other input device. The touch-sensitive surface may also be referred to as a touch screen or a touch panel, and may collect a touch operation of a user on or near the touch-sensitive surface (such as an operation of a user on or near the touch-sensitive surface by using any suitable object or attachment, such as a finger or a stylus), and drive a corresponding connection apparatus according to a preset program. Optionally, the touch-sensitive surface 131 may include two parts: a touch detection apparatus and a touch controller. The touch detection apparatus detects a touch position of the user, detects a signal generated by the touch operation, and transfers the signal to the touch controller. The touch controller receives the touch information from the touch detection apparatus, converts the touch information into touch point coordinates, and sends the touch point coordinates to the processor 1108. Moreover, the touch controller can receive and execute a command sent from the processor 1108. In addition, the touch-sensitive surface may be implemented by using various types, such as a resistive type, a capacitance type, an infrared type, and a surface sound wave type. In addition to the touch-sensitive surface, the input unit 1103 may further include the another input device. Specifically, the another input device may include, but is not limited to, one or more of a physical keyboard, a functional key (such as a volume control key or a switch key), a track ball, a mouse, and a joystick.

The display unit 1104 may be configured to display information input by the user or information provided for the user, and various graphical user ports of the electronic device. The graphical user ports may be formed by a graph, a text, an icon, a video, and any combination thereof. The display unit 1104 may include a display panel. Optionally, the display panel may be configured by using a liquid crystal display (LCD), an organic light-emitting diode (OLED), or the like. Further, the touch-sensitive surface may cover the display panel. After detecting a touch operation on or near the touch-sensitive surface, the touch-sensitive surface transfers the touch operation to the processor 1108, so as to determine a type of a touch event. Then, the processor 1108 provides corresponding visual output on the display panel according to the type of the touch event. Although, in FIG. 9, the touch-sensitive surface and the display panel are used as two separate parts to implement input and output functions, in some embodiments, the touch-sensitive surface and the display panel may be integrated to implement the input and output functions.

The electronic device may further include at least one sensor 1105, such as an optical sensor, a motion sensor, and other sensors. Specifically, the optical sensor may include an ambient light sensor and a proximity sensor. The ambient light sensor may adjust luminance of the display panel 141 according to brightness of the ambient light. The proximity sensor may switch off the display panel 141 and/or backlight when the electronic device is moved to the ear. As one type of motion sensor, a gravity acceleration sensor may detect magnitude of accelerations at various directions (which generally are triaxial), may detect magnitude and a direction of the gravity when static, and may be configured to identify an application of a mobile phone attitude (such as switching between horizontal and vertical screens, a related game, and attitude calibration of a magnetometer), a related function of vibration identification (such as a pedometer and a knock). Other sensors, such as a gyroscope, a barometer, a hygrometer, a thermometer, and an infrared sensor, which may be configured in the electronic device are not further described herein.

The audio circuit 1106, a loudspeaker, and a microphone may provide audio interfaces between the user and the electronic device. The audio circuit 1106 may transmit, to the loudspeaker, a received electric signal converted from received audio data. The loudspeaker converts the electric signal into a sound signal for output. On the other hand, the microphone converts a collected sound signal into an electric signal. The audio circuit 1106 receives the electric signal and converts the electric signal into audio data, and outputs the audio data to the processor 1108 for processing. Then, the processor 1108 sends the audio data to, for example, another terminal by using the RF circuit 1101, or outputs the audio data to the memory 1102 for further processing. The audio circuit 1106 may further include an earplug jack, so as to provide communication between a peripheral earphone and the electronic device.

WiFi belongs to short-distance wireless transmission technology. The electronic devices can help users send and receive email, browsing the web and accessing streaming media through the WiFi module 1107. The WiFi module 1107 provides users with wireless broadband Internet access. Although FIG. 9 shows the WiFi module 1107, it is understandable that it is not a necessary component of an electronic device and can be omitted as necessary without altering the nature of the invention.

The processor 1108 is a control center of the electronic device, and connects various parts of the terminal by using various interfaces and lines. By running or executing the software program and/or module stored in the memory 1102, and invoking data stored in the memory 1102, the processor 1108 performs various functions and data processing of the electronic device, thereby performing overall monitoring on the mobile phone. Optionally, the processor 1108 may include one or more processing cores. Preferably, the processor 1108 may integrate an application processor and a modem. The application processor mainly processes an operating system, a user interface, an application program, and the like. The modem mainly processes wireless communication. It may be understood that, the foregoing modem may not be integrated into the processor 1108.

The electronic device further includes the power supply 1109 (such as a battery) for supplying power to the components. Preferably, the power supply may be logically connected to the processor 1108 by using a power supply management system, thereby implementing functions, such as charging, discharging, and power consumption management, by using the power supply management system. The power supply 1109 may further include any component, such as one or more direct current or alternate current power supplies, a re-charging system, a power supply fault detection circuit, a power supply converter or an inverter, and a power supply state indicator.

The electronic device may further comprise a camera (such as a front camera, a rear camera), a Bluetooth module, and the like, and a description in this regard is not provided. In greater detail, a display unit of the mobile terminal is a touch screen display according to the present embodiment. The mobile terminal further comprises a memory and one or more programs. The one or one or more programs are stored in the memory, and are configured to be executed by one or more processors to perform operations of:
calculating a frame refresh rate of a display device in a time interval between a time when the frame synchronization signal is most recently received and a backlight compensation coefficient calculation time;
obtaining an image frame to be displayed and determining a pixel signal characteristic of the image frame to be displayed;
calculating a backlight compensation coefficient corresponding to the image frame to be displayed based on the frame refresh rate, the pixel signal characteristic and a backlight setting parameter of the display device; and controlling the brightness of the backlight when the image frame to be displayed is displayed on the display device based on the backlight compensation coefficient.

A person skilled in the art may understand that all or part of the steps in the various methods of the above embodiments may be completed by instructions or by hardware controlled by related instructions. The instructions may be stored in a computer-readable storage medium and loaded and executed by a processor.

For this purpose, an embodiment of the present disclosure provides a computer-readable storage medium in which a plurality of instructions are stored capable of being loaded by a processor to perform steps in any of the display overdrive control methods provided in the embodiment of the present disclosure. For example, the instructions executable a processor to perform the following operations comprising:
calculating a frame refresh rate of a display device in a time interval between a time when the frame synchronization signal is most recently received and a backlight compensation coefficient calculation time;
obtaining an image frame to be displayed and determining a pixel signal characteristic of the image frame to be displayed;
calculating a backlight compensation coefficient corresponding to the image frame to be displayed based on the frame refresh rate, the pixel signal characteristic and a backlight setting parameter of the display device;
controlling the brightness of the backlight when the image frame to be displayed is displayed on the display device based on the backlight compensation coefficient.

The specific implementation of each of the above operations can be found in the previous embodiment, which will not be repeated here.

The computer readable storage medium may include: Read Only Memory (ROM), Random Access Memory (RAM), disk or optical disc, etc.

Because the instruction stored in the computer-readable storage medium can execute the steps in any of the display overdrive control methods provided in the embodiments of the present disclosure. Therefore, the beneficial effects that can be achieved by any of method of controlling a brightness of a backlight provided in the embodiments of the present disclosure can be realized, and will not be repeated herein.

According to one aspect of the present disclosure, a computer program product or computer program comprising computer instructions stored in a computer-readable storage medium is also provided. The processor of the electronic device reads the computer instruction from a computer-readable storage medium, and the processor executes the computer instruction so that the electronic device performs the method provided in the various optional implementations in the preceding embodiment.

A backlight brightness control method, apparatus, electronic device and storage medium provided in the embodiment of the present disclosure are described in detail above. The above embodiments of the present disclosure are described in detail, and the principle and embodiment of the present disclosure are elaborated in this article by applying specific examples, and the description of the above embodiments is only used to help understand the technical scheme of the present disclosure and its core ideas A person skilled in the art should understand that he may still modify the technical solutions recorded in the foregoing embodiments, or replace some of the technical features therein. And these modifications or substitutions do not make the essence of the corresponding technical solutions out of the scope of the technical solutions of the embodiments of the present disclosure.

1. A method for controlling a brightness of a backlight, the method comprising:
calculating a frame refresh rate of a display device in a time interval between a time when the frame synchronization signal is most recently received and a backlight compensation coefficient calculation time;
obtaining an image frame to be displayed and determining a pixel signal characteristic of the image frame to be displayed;
calculating a backlight compensation coefficient corresponding to the image frame to be displayed based on the frame refresh rate, the pixel signal characteristic and a backlight setting parameter of the display device; and
controlling the brightness of the backlight when the image frame to be displayed is displayed on the display device based on the backlight compensation coefficient.

2. The method of claim 1, wherein the calculating a frame refresh rate of a display device in a time interval between a time when the frame synchronization signal is most recently received and a backlight compensation coefficient calculation time, comprises:
obtaining a frame synchronization signal and setting a number of signal receptions corresponding to a backlight refresh synchronization signal to 0 in response to the frame synchronization signal, wherein a frequency of the backlight refresh synchronization signal is greater than a frequency of the frame synchronization signal;
receiving the backlight refresh synchronization signal and increasing the number of signal receptions by 1 according to the backlight refreshing synchronization signal;
returning to perform the step of receiving the backlight refresh synchronization signal until the backlight compensation coefficient calculation time; and
determining a current number of signal receptions at the backlight compensation coefficient calculation time, and calculating the frame refresh rate of the display device in the time interval between the time when the frame synchronization signal is most recently received and the backlight compensation coefficient calculation time according to the current number of signal receptions and a backlight refresh frequency of the display device.

3. The method of claim 2, wherein the step of calculating the frame refresh rate of the display device in the time interval between the time when the frame synchronization signal is most recently received and the backlight compensation coefficient calculation time according to the current number of signal receptions and the backlight refresh frequency of the display device comprises:
calculating a duration between the time when the frame synchronization signal is most recently received and the backlight compensation coefficient calculation time according to the number of signal receptions and the backlight refresh rate of the display device;
based on the duration, calculating the frame refresh rate of the display device in the time interval between the time when the frame synchronization signal is most recently received and the backlight compensation coefficient calculation time.

4. The method of claim 1, wherein the obtaining an image frame to be displayed and determining a pixel signal characteristic of the image frame to be displayed, comprises:
obtaining the image frame to be displayed and counting a number of pixels corresponding to the image frame to be displayed in a preset pixel value interval; and
calculating the pixel signal characteristic of the image frame to be displayed based on the number of pixels corresponding to the image frame to be displayed in each pixel value interval.

5. The method of claim 4, wherein the step of calculating the pixel signal characteristic of the image frame to be displayed based on the number of pixels corresponding to the image frame to be displayed in each pixel value interval comprises:
calculating a pixel signal average value corresponding to the image frame to be displayed in a preset statistical interval and a proportion of the number of pixels corresponding to each statistical interval based on the number of pixels corresponding to the image frame to be displayed in each pixel value interval;
determining a pixel signal adjustment coefficient corresponding to the pixel signal average value from a preset adjustment coefficient mapping relationship based on the pixel signal average value and the proportion of the number of pixels; and
performing a weighted calculation according to each pixel signal average value and a pixel signal adjustment coefficient corresponding to each pixel signal average value to obtain the pixel signal characteristics of the image frame to be displayed.

6. The method of claim 5, wherein the step of calculating the pixel signal average value corresponding to the image frame to be displayed in the preset statistical interval and the proportion of the number of pixels corresponding to each statistical interval based on the number of pixels corresponding to the image frame to be displayed in each pixel value interval comprises:
calculating the pixel signal average value corresponding to the image frame to be displayed in the preset statistical interval based on the number of pixels corresponding to the image frame to be displayed in each pixel value interval and a maximum value corresponding to each pixel value interval; and
calculating the proportion of the number of pixels corresponding to the image frame to be displayed in each statistical interval based on a total number of pixels of the image frame to be displayed and the number of pixels in each pixel value interval corresponding to the statistical interval.

7. The method of claim 1, wherein the calculating a backlight compensation coefficient corresponding to the image frame to be displayed based on the frame refresh rate, the pixel signal characteristic and a backlight setting parameter of the display device, comprises:
obtaining a first brightness data set corresponding to the display device, wherein the first brightness data set comprises at least a group of candidate pixel signal values and corresponding brightness data under a candidate frame refresh rate;
determining target brightness data under the frame refresh rate and the pixel signal characteristic from the first brightness data set according to the frame refresh rate and the pixel signal characteristics; and
calculating the backlight compensation coefficient corresponding to the image frame to be displayed based on the backlight setting parameter of the display device and the target brightness data.

8. The method of claim 7, wherein the step of obtaining the first brightness data set corresponding to the display device comprises:
utilizing the control signal source to output a preset candidate pixel signal value through the display device under a preset candidate frame refresh rate, wherein the candidate frame refresh rate is a value within a preset frame refresh rate range, and the candidate pixel signal value is a value within a preset pixel signal value range;
obtaining the brightness data of the display device under the candidate frame refresh rate and the candidate pixel signal value;
modifying the candidate frame refresh rate and the candidate pixel signal value to obtain a new preset candidate frame refresh rate and a new preset candidate pixel signal value; and
returning to the step of performing a signal source controlling the display device to output the preset candidate pixel signal values at the preset candidate frame refresh rate, until obtaining the first brightness data of the display device under the output of each candidate pixel signal value in the range of each candidate frame in the frame refresh rate range, and generating a first brightness data set corresponding to the display device.

9. The method of claim 7, wherein the step of calculating the backlight compensation coefficient corresponding to the image frame to be displayed based on the backlight setting parameter of the display device and the target brightness data comprises:
determining a brightness change interval corresponding to the backlight setting parameter from a preset brightness change curve based on the backlight setting parameter of the display device, and calculating a curve slope of the brightness change interval;
obtaining a target brightness adjustment interval corresponding to the brightness change interval according to a ratio of the target brightness data and the curve slope;
for the target brightness adjustment interval, calculating the brightness adjustment value under at least one preset adjustment step;
determining the target brightness adjustment value satisfying a brightness condition from the brightness adjustment value under each adjustment step based on the target brightness data; and
taking the adjustment step corresponding to the target brightness adjustment value as the backlight compensation coefficient corresponding to the image frame to be displayed.

10. The method of claim 9, further comprising following steps before the step of determining the brightness change interval corresponding to the backlight setting parameter from a preset brightness change curve:
controlling the signal source of the display device to output a preset pixel signal value under a preset candidate backlight setting parameter, wherein the candidate backlight setting parameter is a value within a preset backlight setting parameter range;
obtaining the brightness data of the display device under the candidate frame refresh rate and the pixel signal value;
modifying the candidate frame refresh rate to obtain a new preset candidate frame refresh rate;
returning to the step of controlling the signal source of the display device to output a preset pixel signal value under a preset candidate backlight setting parameter, until second brightness data of the display device under each candidate backlight setting parameter in the backlight setting parameter range is obtained; and
generating the brightness change curve based on the second brightness data.

11-17. (canceled)

18. An electronic device, comprising a processor and a memory storing an application executable by the processor to perform operations comprising:
calculating a frame refresh rate of a display device in a time interval between a time when the frame synchronization signal is most recently received and a backlight compensation coefficient calculation time;
obtaining an image frame to be displayed and determining a pixel signal characteristic of the image frame to be displayed;
calculating a backlight compensation coefficient corresponding to the image frame to be displayed based on the frame refresh rate, the pixel signal characteristic and a backlight setting parameter of the display device; and
controlling the brightness of the backlight when the image frame to be displayed is displayed on the display device based on the backlight compensation coefficient.

19-20. (canceled)

21. The method of claim 18, wherein the calculating a frame refresh rate of a display device in a time interval between a time when the frame synchronization signal is most recently received and a backlight compensation coefficient calculation time, comprises:
obtaining a frame synchronization signal and setting a number of signal receptions corresponding to a backlight refresh synchronization signal to 0 in response to the frame synchronization signal, wherein a frequency of the backlight refresh synchronization signal is greater than a frequency of the frame synchronization signal;
receiving the backlight refresh synchronization signal and increasing the number of signal receptions by 1 according to the backlight refreshing synchronization signal;
returning to perform the step of receiving the backlight refresh synchronization signal until the backlight compensation coefficient calculation time; and
determining a current number of signal receptions at the backlight compensation coefficient calculation time, and calculating the frame refresh rate of the display device in the time interval between the time when the frame synchronization signal is most recently received and the backlight compensation coefficient calculation time according to the current number of signal receptions and a backlight refresh frequency of the display device.

22. The electronic device of claim 21, wherein the operation of calculating the frame refresh rate of the display device in the time interval between the time when the frame synchronization signal is most recently received and the backlight compensation coefficient calculation time according to the current number of signal receptions and the backlight refresh frequency of the display device comprises:
calculating a duration between the time when the frame synchronization signal is most recently received and the backlight compensation coefficient calculation time according to the number of signal receptions and the backlight refresh rate of the display device;
based on the duration, calculating the frame refresh rate of the display device in the time interval between the time when the frame synchronization signal is most recently received and the backlight compensation coefficient calculation time.

23. The electronic device of claim 18, wherein the obtaining an image frame to be displayed and determining a pixel signal characteristic of the image frame to be displayed, comprises:
obtaining the image frame to be displayed and counting a number of pixels corresponding to the image frame to be displayed in a preset pixel value interval; and
calculating the pixel signal characteristic of the image frame to be displayed based on the number of pixels corresponding to the image frame to be displayed in each pixel value interval.

24. The electronic device of claim 23, wherein the operation of calculating the pixel signal characteristic of the image frame to be displayed based on the number of pixels corresponding to the image frame to be displayed in each pixel value interval comprises:
calculating a pixel signal average value corresponding to the image frame to be displayed in a preset statistical interval and a proportion of the number of pixels corresponding to each statistical interval based on the number of pixels corresponding to the image frame to be displayed in each pixel value interval;
determining a pixel signal adjustment coefficient corresponding to the pixel signal average value from a preset adjustment coefficient mapping relationship based on the pixel signal average value and the proportion of the number of pixels; and
performing a weighted calculation according to each pixel signal average value and a pixel signal adjustment coefficient corresponding to each pixel signal average value to obtain the pixel signal characteristics of the image frame to be displayed.

25. The electronic device of claim 24, wherein the operation of calculating the pixel signal average value corresponding to the image frame to be displayed in the preset statistical interval and the proportion of the number of pixels corresponding to each statistical interval based on the number of pixels corresponding to the image frame to be displayed in each pixel value interval comprises:
calculating the pixel signal average value corresponding to the image frame to be displayed in the preset statistical interval based on the number of pixels corresponding to the image frame to be displayed in each pixel value interval and a maximum value corresponding to each pixel value interval; and
calculating the proportion of the number of pixels corresponding to the image frame to be displayed in each statistical interval based on a total number of pixels of the image frame to be displayed and the number of pixels in each pixel value interval corresponding to the statistical interval.

26. The electronic device of claim 18, where the calculating a backlight compensation coefficient corresponding to the image frame to be displayed based on the frame refresh rate, the pixel signal characteristic and a backlight setting parameter of the display device, comprises:
obtaining a first brightness data set corresponding to the display device, wherein the first brightness data set comprises at least a group of candidate pixel signal values and corresponding brightness data under a candidate frame refresh rate;
determining target brightness data under the frame refresh rate and the pixel signal characteristic from the first brightness data set according to the frame refresh rate and the pixel signal characteristics; and
calculating the backlight compensation coefficient corresponding to the image frame to be displayed based on the backlight setting parameter of the display device and the target brightness data.

27. The electronic device of claim 26, wherein the operation of obtaining the first brightness data set corresponding to the display device comprises:
utilizing the control signal source to output a preset candidate pixel signal value through the display device under a preset candidate frame refresh rate, wherein the candidate frame refresh rate is a value within a preset frame refresh rate range, and the candidate pixel signal value is a value within a preset pixel signal value range;
obtaining the brightness data of the display device under the candidate frame refresh rate and the candidate pixel signal value;
modifying the candidate frame refresh rate and the candidate pixel signal value to obtain a new preset candidate frame refresh rate and a new preset candidate pixel signal value; and
returning to the operation of performing a signal source controlling the display device to output the preset candidate pixel signal values at the preset candidate frame refresh rate, until obtaining the first brightness data of the display device under the output of each candidate pixel signal value in the range of each candidate frame in the frame refresh rate range, and generating a first brightness data set corresponding to the display device.

28. The electronic device of claim 26, wherein the operation of calculating the backlight compensation coefficient corresponding to the image frame to be displayed based on the backlight setting parameter of the display device and the target brightness data comprises:
determining a brightness change interval corresponding to the backlight setting parameter from a preset brightness change curve based on the backlight setting parameter of the display device, and calculating a curve slope of the brightness change interval;
obtaining a target brightness adjustment interval corresponding to the brightness change interval according to a ratio of the target brightness data and the curve slope;
for the target brightness adjustment interval, calculating the brightness adjustment value under at least one preset adjustment step;
determining the target brightness adjustment value satisfying a brightness condition from the brightness adjustment value under each adjustment step based on the target brightness data; and
taking the adjustment step corresponding to the target brightness adjustment value as the backlight compensation coefficient corresponding to the image frame to be displayed.

29. The electronic device of claim 28, wherein before the operation of determining the brightness change interval corresponding to the backlight setting parameter from a preset brightness change curve, the operations further comprise:
controlling the signal source of the display device to output a preset pixel signal value under a preset candidate backlight setting parameter, wherein the candidate backlight setting parameter is a value within a preset backlight setting parameter range;
obtaining the brightness data of the display device under the candidate frame refresh rate and the pixel signal value;
modifying the candidate frame refresh rate to obtain a new preset candidate frame refresh rate;
returning to the operation of controlling the signal source of the display device to output a preset pixel signal value under a preset candidate backlight setting parameter, until second brightness data of the display device under each candidate backlight setting parameter in the backlight setting parameter range is obtained; and
generating the brightness change curve based on the second brightness data.
